(19) United States
(12) Patent Application Publication
(10) Pub. No.: US 2016/0076936 A1
(43) Pub. Date: Mar. 17, 2016

(54) METHOD OF ATTACHING CAMERA OR IMAGING SENSOR TO TEST AND MEASUREMENT TOOLS

(71) Applicant: Fluke Corporation, Everett, WA (US)

(72) Inventors: Michael A. Schoch, Granite Falls, WA (US); Michael D. Stuart, Issaquah, WA (US); Jeffrey E. Worones, Seattle, WA (US); Charles E. Marzette, JR., Kirkland, WA (US); Christopher W. Lagerberg, Seattle, WA (US); Michele F. Bartoli, Lynnwood, WA (US)

(21) Appl. No.: 14/855,844

(22) Filed: Sep. 16, 2015

Related U.S. Application Data
(60) Provisional application No. 62/051,909, filed on Sep. 17, 2014.
(60) Provisional application No. 62/051,927, filed on Sep. 17, 2014.

(51) Int. Cl. G01J 1/44; G01J 1/02

(52) U.S. Cl. CPC G01J 1/44; G01J 1/0271

(57) ABSTRACT

Imaging tools can be fixedly or removably attached to various surfaces of test and measurement tools. An imaging tool comprising a sensor array capable of receiving electromagnetic radiation from a target scene can be configured to engage a surface of the test and measurement tool such that the imaging tool is supported by the test and measurement tool. When the imaging tool is engaged with the test and measurement tool, the sensor array can be movable relative to the imaging tool so that a target scene viewed by the sensor array of the imaging tool is adjustable without requiring movement of the test and measurement tool.

### CROSS-REFERENCES

This application claims the benefit of U.S. Provisional Application No. 62/051,909, filed Sep. 17, 2014, and U.S. Provisional Application No. 62/051,927, filed Sep. 17, 2014, the content of which is hereby incorporated by reference in its entirety.

### BACKGROUND

Imaging tools attached or built in to other tools (e.g., test and measurement tools) can be used to acquire image data that is supplementary to other data acquired by the test and measurement tool. Such supplementary information can be useful in performing various measurements, for example, by providing extra context to data acquired by a technician performing a measurement task. However, in various test and measurement tools are most conveniently used (or in some cases, must be used) in only a variety of orientations. A limited number of orientations of the test and measurement tool allows only a limited number of orientations of an integrated imaging tool, limiting the imaging functionality of the device. On the other hand, orienting the test and measurement tool to acquire desired image data may make performing a function of the test and measurement tool difficult or impossible.

### SUMMARY

Embodiments of the invention are directed to systems and methods that provide adjustable imaging tools attached to test and measurement tools. Exemplary systems can include a test and measurement tool having a first surface and configured to generate measurement data representative of at least one parameter of an object under test. The system can include an imaging tool that includes a sensor array for receiving radiation from a target scene and configured to generate image data representative of a target scene. The imaging tool can be configured to fixedly or removably engage the first surface of the test and measurement tool such that the imaging tool is supported by the test and measurement tool. The imaging tool can be configured such that, when the imaging tool is engaged with the first surface of the test and measurement tool, the sensor array of the imaging tool is movable relative to the imaging tool such that the target scene is adjustable without movement of the test and measurement tool.

In various examples, the sensor array of the imaging tool can be movable by a variety of mechanisms. For example, in some embodiments, the imaging tool is mounted to the test and measurement tool by a rotatable mount, such as a gimbal mount. In such an embodiment, the sensor array can be rotated to adjust the target scene detected by the sensor array. Additionally or alternatively, the imaging tool can include an elongate portion that is flexible and/or telescoping. In such embodiments, motion of the elongate portion of the imaging tool can result in motion of the sensor array relative to the test and measurement tool.

### BRIEF DESCRIPTION OF THE DRAWINGS

FIGS. 1A and 1B provide front and back views of an exemplary system including a test and measurement tool and an imaging tool.

FIG. 2 is an exemplary schematic diagram of a test and measurement tool comprising a variety of components.

FIG. 3 shows an example block diagram of an imaging tool configured for receiving electromagnetic radiation according to some exemplary systems.

FIG. 4 illustrates an exemplary embodiment of a test and measurement tool configured to receive an imaging component.

FIG. 5 is another test and measurement tool configured to receive an imaging component.

FIG. 6 is an exemplary system including an imaging tool capable of interfacing with a test and measurement tool.

FIGS. 7A and 7B show exemplary imaging tools for attachment to a test and measurement tool.

FIG. 8 is an exemplary embodiment of an imaging tool coupled to a test and measurement tool.

FIG. 9 is an exemplary display showing combined image and measurement data.

### DETAILED DESCRIPTION

Embodiments of the invention generally relate to methods of attaching cameras or other imaging sensors to a variety of test and measurement tools or otherwise providing an interface between such devices. Test and measurement tools can be generally capable of determining at least one parameter of a device under test. Exemplary test and measurement tools can include, but are not limited to, digital multimeters, current measurement tools, power quality tools, vibration tools, portable oscilloscope tools, laser alignment tools, ultrasonic test tools, insulation resistance testers, multi-function electrical test tools, single-function electrical test tools, contact temperature measurement tools, humidity measurement tools, air-flow measurement tools, air temperature measurement tools , air quality and particulate measurement tools, and the like.

Often, a test and measurement tool includes one or more surfaces on which one or more imaging devices (e.g., camera, imaging sensors) can be securely mounted or otherwise attached. Various surfaces may be suitable for accommodating the mounting of an imaging device. For example, substantially planar surfaces, partially-planar surfaces, and rounded surfaces all may be suitable to support a mounted imaging device. One or more imaging devices to be attached to a test and measurement tool can be sensitive to any of a variety of wavelengths. Exemplary imaging components can include sensors which can detect visible, near infrared (NIR), short-wavelength infrared (SWIR), long wavelength infrared (LWIR), terahertz (THz), ultraviolet (UV), X-Ray or other wavelengths. In some embodiments, the imaging component can include one or more imaging sensors, for example, infrared (IR) and visible light (VL) cameras.

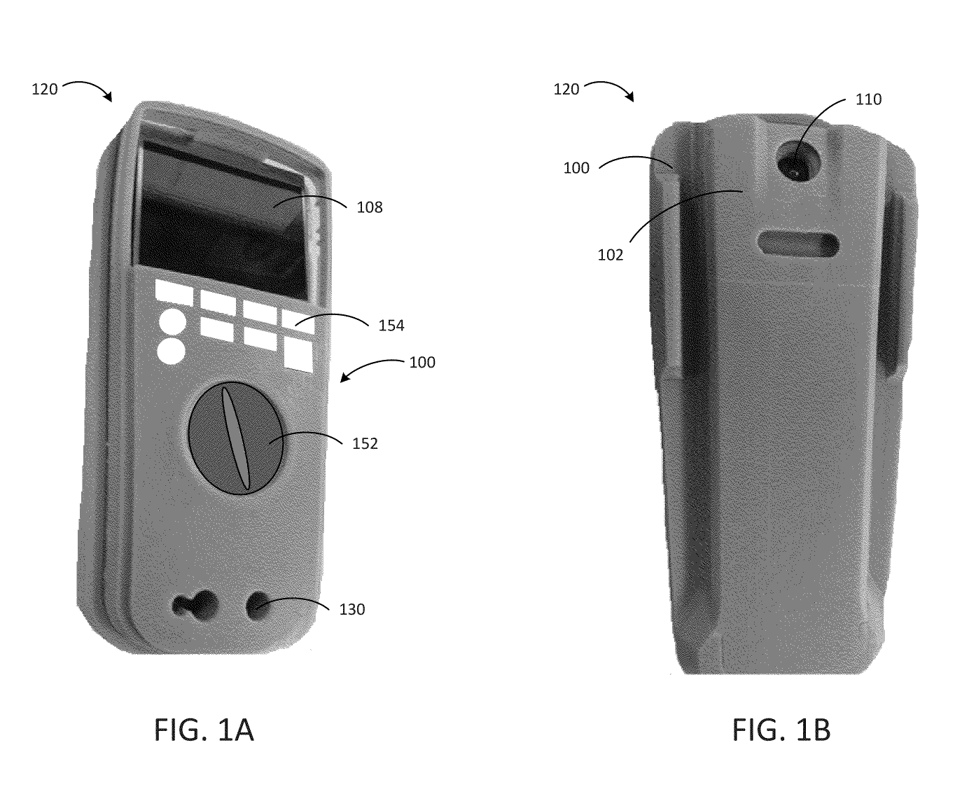

FIGS. 1A and 1B provide front and back views of an exemplary system including a test and measurement tool and an imaging tool. The embodiment of FIGS. 1A and 1B includes a test and measurement tool 100 and an imaging tool 110 combined into a single combination tool 120. In the illustrated embodiment, test and measurement tool 100 includes a back surface 102 through which the imaging tool 110 operates.

In some examples, imaging tool 110 can include a plurality of sensing components. For example, imaging tool 110 may include one or both of an infrared (IR) camera and a visible light (VL) camera. It will be appreciated that various imaging tools such as 110 can include any combination of appropriate sensors capable of detecting a variety of wavelengths.

In the example of FIGS. 1A and 1B, imaging tool 110 is integrated into test and measurement tool 100. That is, the system of FIG. 1 shows a combination tool 120 having integral test and measurement tool 100 and imaging tool 110. Imaging tool 110 includes a camera capable of detecting radiation in one or more ranges of wavelengths. As described, imaging tool 110 may include a plurality of cameras for detecting radiation in different wavelength spectrums. In some examples, the imaging tool may include a plurality of sensor arrays, each sensor array sensitive to a different range of wavelengths. Some such embodiments include optics for separating light incident to imaging tool and substantially directing light within certain wavelength ranges to corresponding sensor arrays.

The combination tool 120 of FIGS. 1A and 1B may be configured to generate image data and measurement data substantially simultaneously. In some examples, combination tool 120 includes a display (not shown) capable of presenting one or more of image data, measurement data, or other information. Additionally or alternatively, any one or more of the test and measurement tool 100, imaging tool 110, and combination tool 120 can communicate one or more of measurement data, image data, or combined measurement and image data to any other system component. In some examples, such data may be communicated to an external device, as described in U.S. patent application Ser. No. 14/855,989, filed Sep. 16, 2015, and entitled “DISPLAY OF IMAGES FROM AN IMAGING TOOL EMBEDDED OR ATTACHED TO A TEST AND MEASUREMENT TOOL,” which is assigned to the assignee of the instant application, and which is hereby incorporated by reference in its entirety.

In the front view of FIG. 1A, the tool 120 includes inputs 130, for example, for receiving one or more accessories (e.g., test leads). The one or more accessories can be used for interfacing with an object under test for generating measurement data representative of at least one parameter of a device under test. In some embodiments, test and measurement tool 100 in combination tool 120 may perform a plurality of different measurement functions via inputs 130. In some embodiments, the measurement function is selectable, for example, via a user interface 150. Interface 150 can include one or more elements by which a user can interact with the tool 120, such as a selection knob 152 or buttons 154, or other interface elements such as a touchscreen, switches, and the like.

Combined tool 120 includes a display 108. Display 108 can be used to present various information to the user. In some examples, display 108 can be configured to present measurement data generated by the test and measurement tool 100. Additionally or alternatively, the display 108 can be configured to present image data generated by imaging tool 110. In some embodiments, a combination of measurement data and image data can be presented on the display 108 for presentation to a user.

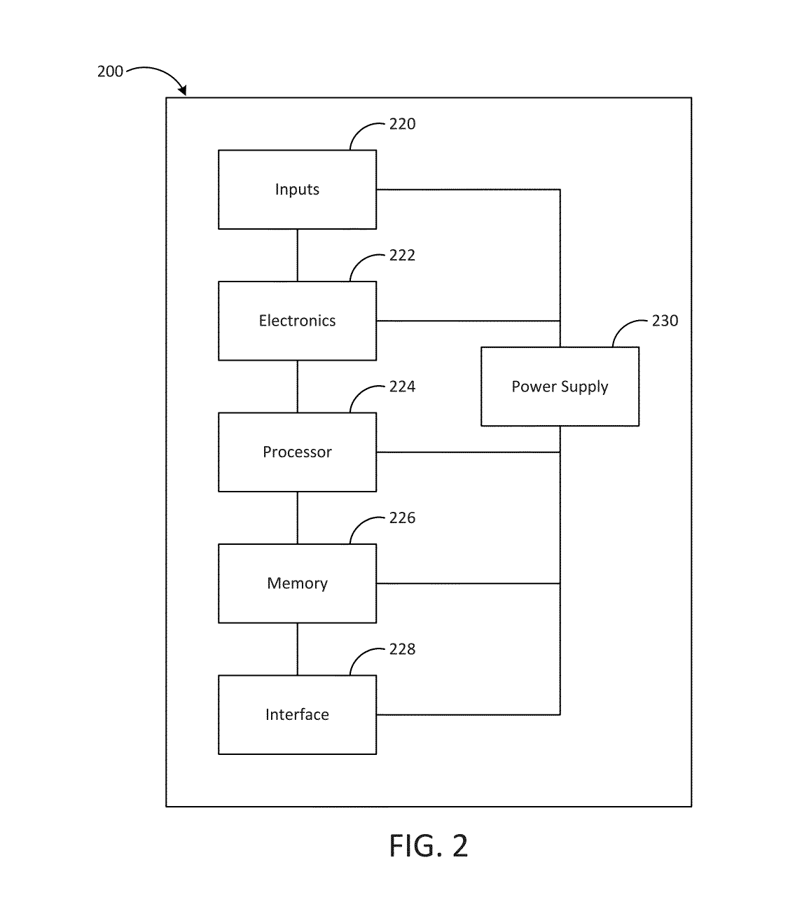

FIG. 2 is an exemplary schematic diagram of a test and measurement tool comprising a variety of components. In the illustrated example, the test and measurement tool 200 may include one or power supplies 230 for providing electrical power to any of a variety of system components for performing a variety of tasks, such a performing one or more primary functions. In some embodiments, the one or more power supplies 230 may include one or more batteries. Additionally or alternatively, the test and measurement tool 200 may be capable of running on AC power, e.g., from a standard wall receptacle. In some such embodiments, one or more batteries of the test and measurement tool 200 may be charged while the tool 200 is operating on or otherwise plugged into an AC power source.

The test and measurement tool may include one or more inputs 220 configured to interface with an object under test for performing a measurement of a parameter thereof. In various examples, the one or more inputs 220 may include any appropriate input for performing a measurement of a parameter of a device under test. The one or more inputs 220 may provide a signal indicative the parameter of the object under test to any combination of electronics 222 and a processor 224 for further processing of the signal. In some examples, the test and measurement tool 200 includes a memory 226 for storing information indicative of one or more parameters of a device under test. In some embodiments, one or both of processor 224 and memory 226 may be integrated into electronics 222.

In some embodiments, test and measurement tool 200 may include an interface 228 for interacting with a user. In some examples, interface 228 may include one or more controls for receiving user inputs. Controls may include, for example, buttons, switches, knobs, touch screens, etc. In some embodiments, a user may initiate a measurement or other test and measurement tool 200 function using controls. Additionally or alternatively, the interface may include a display for communicating information to a user. For example, the display may present a user with selectable options, such as various functions selectable by the user via controls. Additionally or alternatively, the display may be configured to present the results of one or more measurements performed by the test and measurement tool for observation by a user. In some examples, a display is capable of presenting textual measurement information (e.g., letters, numbers, etc.), but is not capable of displaying image information, such as described elsewhere herein. Additionally or alternatively, in some embodiments, power supply 230 is not capable of supporting a continuous image display without severely depleting the available power supply. Thus, in some examples, presentation of image data via interface 228 may be impossible or impractical.

In some examples, interface 228 may provide an interface with additional equipment. For example, in some embodiments, interface 228 can provide a communication interface between the test and measurement tool 200 and an imaging tool (e.g., 110) or an external device (e.g., smartphone, tablet, etc.). In various embodiments, interface 228 can be used to export received measurement data, such as from inputs 220, or a processed result, for example, from processor 224.

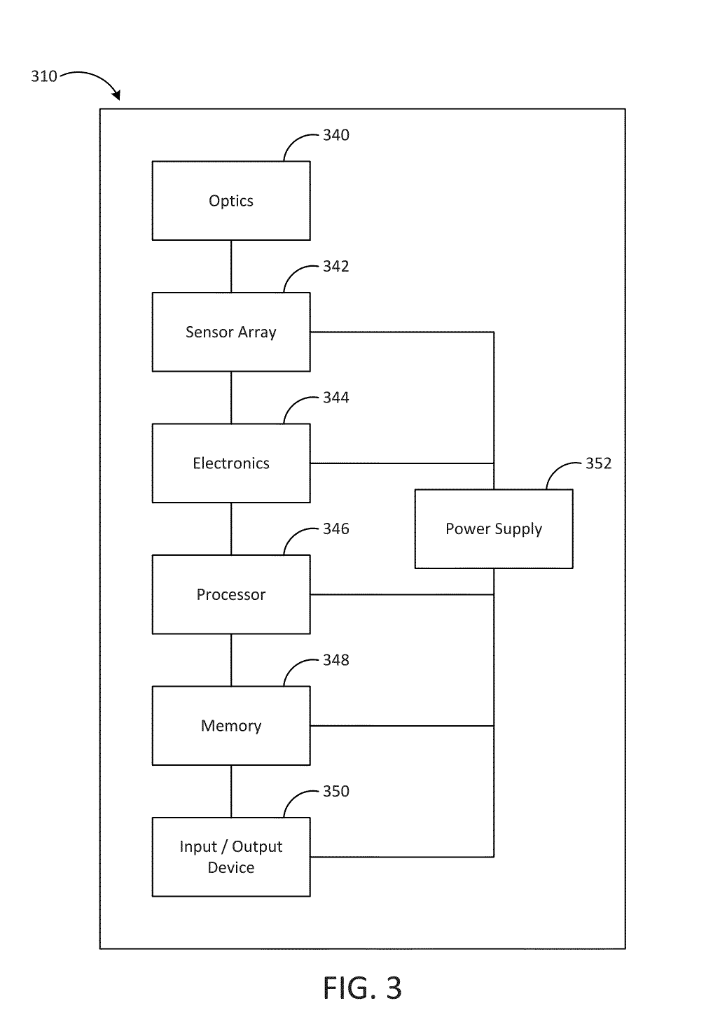

FIG. 3 shows an example block diagram of an imaging tool configured for receiving electromagnetic radiation according to some exemplary systems. In the illustrated embodiment, imaging tool 310 includes optics 340, a sensor array 342, electronics 344, one or more processors 346, memory units 348, input/output devices 350, and a power supply 352.

The optics 340 can include optics for focusing, deflecting, and/or reflecting electromagnetic radiation from a target object onto the sensor array 342. In some examples, the sensor array 342 may include an infrared sensor array sensitive to infrared radiation. An imaging tool including such an infrared sensor array may be used to make non-contact temperature measurements.

In such embodiments, the infrared sensor array 342 can include one or more thermal detectors such as microbolometers or thermopiles, or could be composed of photon detectors such as photodiodes or phototransistors, or other thermal or photon detection device. In some examples, an infrared sensor array may include a single detector, for instance, for determining a spot temperature within a target scene. Alternatively, an infrared sensor array may comprise a plurality of such detectors for acquiring at least one of a spot temperature (e.g., via an average value of sensor array sensors) and a two-dimensional infrared image.

One of skill in the art will recognize that various sensor arrays (e.g. photon sensor arrays) can be used, and can be used in combination with one or more infrared sensor arrays. In some examples, the sensor array is fixed within the imaging tool 310 to provide a more durable device having fewer moving and moveable parts. In various examples, the size and positioning of the detector depends on the characteristics of the optical system (e.g., the relationship between optics 340 and sensor array 342). In some embodiments, the detector is generally circular having a diameter of 0.5 mm to 3 mm. However detectors of any size and shape should be considered within the scope of the invention. The detector produces a signal as a function of the radiation or other scene data imaged thereupon. These signals can be processed by known methods to indicate a temperature or other metric indicated via the received radiation.

A person of skill in the art will recognize that many materials and materials technologies may be suitable for use in an infrared sensor array. In some examples, the infrared sensor array 342 responds to infrared radiation ranging from approximately 0.7 microns to approximately 30 microns and can have a peak sensitivity within this range. The electronics 344 receive the output signals from the sensor array 342 and pass them to the processor 346 for analysis.

When an infrared sensor assembly is used, the processor 346 can be used to run infrared thermometer applications including, but not limited to, deciding if the target object sufficiently fills the field of view, and averaging output signals for a period of time to reduce the impact of noisy measurements on the accuracy of the measured temperature. In the case of alternative sensor arrays (e.g., sensitive to one or more of visible light, ultraviolet light, X-rays, etc.), the processor 346 may be used to run corresponding imaging applications.

Memory 348 can include but is not limited to, RAM, ROM, and any combination of volatile and non-volatile memory. A power supply 352 can include, but is not limited to, a battery, a parasitic energy system (e.g., an inductive system), and components for directly receiving AC power. The power supply 352 can provide power to the sensor array 342, electronics 344, processor 346, memory 348, and/or input/output devices 350. An input/output device 350 can include, but is not limited to, triggers to start and stop the image capture, visual displays, speakers, and communication devices that operate through wired or wireless communications.

For instance, in some examples, the input/output device 350 of the imaging tool 310 can include a display capable of displaying an image produced from data conveyed or captured by one or more sensor arrays 342. In some examples, the display can be further configured to show other data, for instance, data from the test and measurement tool (e.g., via communication port 104) or other external sources. Additionally or alternatively, input/output device 350 may be capable of one or more of receiving measurement data from a measurement tool and communicating at least one of image data and received measurement data to an external device, such as a tablet, smartphone, computer, etc.

In some instances, planar or other surfaces such as those referenced above (e.g., surface 102) capable of receiving an imaging component (e.g., imaging tool 110 are not necessarily conducive to operation of the imaging component once it has been mounted. For example, ergonomically poor configurations of mounted imaging components can be inconvenient to a user, and can contribute to difficulty in aiming any attached on-board imaging components. Additionally or alternatively, simultaneous operation of a test and measurement tool and an attached imaging tool may be difficult or impossible depending on the orientation of the imaging tool. Accordingly, by mounting the imaging component with a well-suited attachment mechanism, aiming of the camera can better fit the use model of the particular test tool, and also provide more control for the user.

Attachment mechanisms for mounting an imaging component to a test and measurement tool can include a rotating or gimbal-style protrusion or insert. In some examples, executions of this concept can include, but are not limited to the incorporate of, omnidirectional gimbal/ball mounts, planar gimbal/ball mounts, rotating cylinders or blocks, planar gimbal mounts with rotation, and limited conical direction gimbal/ball mounts. Utilizing such attachment mechanisms to mount an imaging component into a test and measurement tool can facilitate enhanced usability of the imaging component while maintaining operation of the test and measurement tool. The attachment mechanisms can facilitate aiming of the imaging component in order to conveniently capture image data of a target scene.

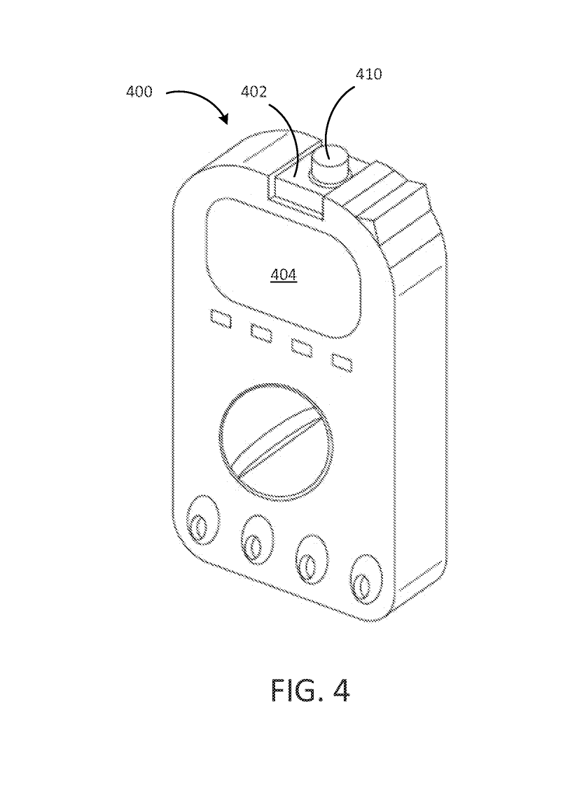

FIG. 4 illustrates an exemplary embodiment of a test and measurement tool configured to receive an imaging component. Test and measurement tool 400 includes an attachment mechanism 402 for receiving an imaging component 410. The attachment mechanism 402 can facilitate partial or full rotation of an attached imaging component 410 configured to generate image data. In some examples, the attachment mechanism 402 can facilitate rotation in one or more of a variety of directions, such as azimuthal rotation, tip, tilt, or any combination thereof. Attaching the imaging component to the test and measurement tool 400 via the attachment mechanism 402 can enable communication between the test and measurement tool 400 and the attached imaging component 410. The communication can be wired or wireless.

The test and measurement tool 400 can be configured to measure at least one parameter of a device under test and to generate measurement data related to the at least one measured parameter. In the illustrated embodiment, the test and measurement tool 400 includes a display 404. The display 404 can be used to display measurement data generated by the test and measurement tool 400. In the event that the imaging component 410 is in communication with the test and measurement tool 400, in some embodiments, the display 404 can display image data generated by the imaging component 410. In some embodiments, for example, in the event that the imaging component 410 includes IR and VL imaging sensors, the test and measurement tool 400 can present a combined IR and VL image on the display 404. Combination images can include, for example, those described in U.S. Pat. No. 7,535,002, entitled “CAMERA WITH VISIBLE LIGHT AND INFRARED BLENDING,” which is assigned to the assignee of the instant application, and which is hereby incorporated by reference in its entirety.

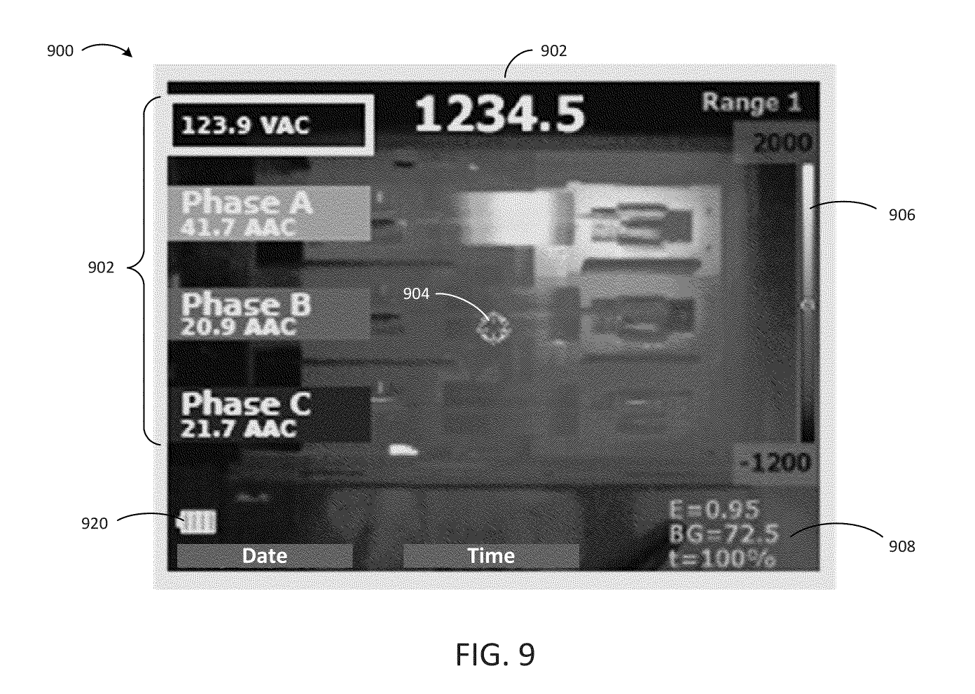

In some examples, the test and measurement tool 400 can combine the image data and the measurement data as described in U.S. Patent Publication No. US20140278259, corresponding to U.S. patent application Ser. No. 14/214,600, filed Mar. 14, 2014, and entitled “CAPTURE AND ASSOCIATION OF MEASUREMENT DATA,” which is assigned to the assignee of the instant application, and which is hereby incorporated by reference in its entirety. The combined measurement data and image data can be presented simultaneously on the display 404. Image and measurement data can be processed to generate a display comprising both the image data and the measurement data for presentation to a user such as is shown in FIG. 9.

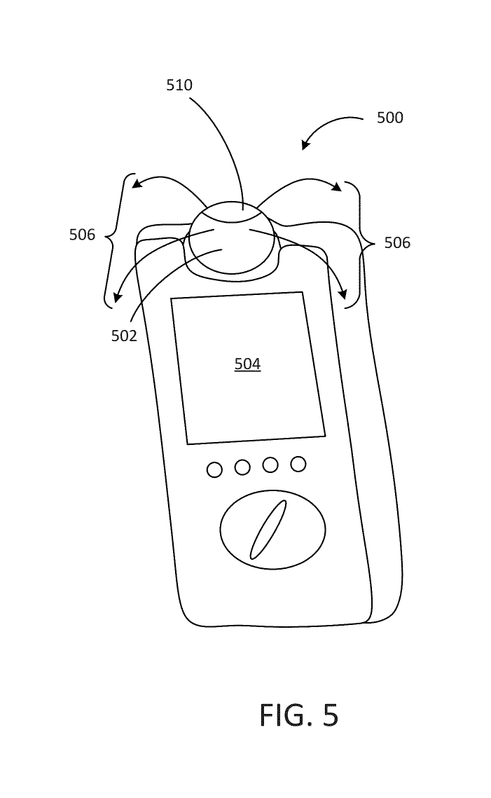

FIG. 5 is another test and measurement tool configured to receive an imaging component. The test and measurement tool 500 of FIG. 5 includes an attachment mechanism 502 configured to receive an imaging component 510. The attachment mechanism 502 of FIG. 5 comprises an omnidirectional ball or gimbal mount, permitting rotation in the direction of any of arrows 506 or any combination of such directions. Such an attachment mechanism 502 permits a wide degree of motion by an attached imaging component 510 to facilitate the imaging of a variety of target scenes. Operation and communication of the test and measurement tool 500 and an imaging component 510 via attachment mechanism 502 can be performed similarly to the embodiment described with respect to FIG. 4.

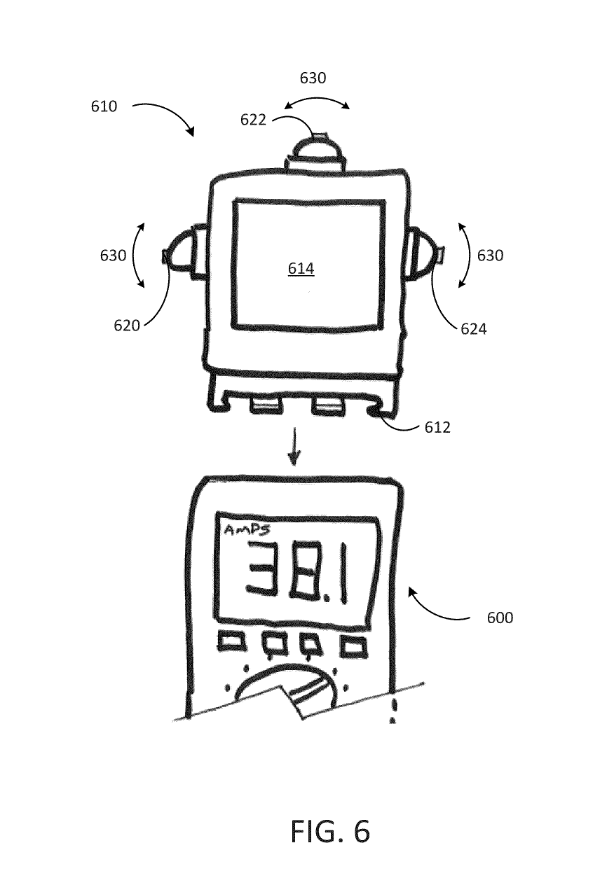

FIG. 6 is an exemplary system including an imaging tool capable of interfacing with a test and measurement tool. Imaging tool 610 includes a variety of imaging components 620, 622, 624. While shown as being on various sides of the imaging tool 610 for multi-directional viewing, imaging components 620, 622, 624 can be positioned proximate one another, for example on a single side of imaging tool 610, for simultaneous imaging of a similar target scene. As described, imaging components can include imaging sensor which can be sensitive to light in any of a variety of wavelengths. In general, imaging tool 610 can include any number of individual imaging components. For instance, in some examples, the imaging tool 610 includes first and second imaging components, wherein the first imaging component comprises an IR imaging sensor and the second imaging component comprises a VL imaging sensor.

Imaging tool 610 includes an attachment mechanism 612 for attaching to a test and measurement tool 650. When attached, the imaging tool 610 can be in wired or wireless communication with the test and measurement tool 650. In some embodiments, the imaging tool 610 can rotate about an axis so as to facilitate movement in the direction of arrows 630. Such movement can be facilitated by the attachment mechanism 612 of the imaging tool 610, or the test and measurement tool 600. Imaging tool 610 further includes a display 614 configured to display image data generated by the imaging tool 610. In some embodiments, the display 614 can be configured to display measurement data received from a test and measurement tool, or a combination of image data and measurement data as described regarding the test and measurement tools (400, 500) of FIGS. 4 and 5, and in the incorporated reference.

In some embodiments, an imaging tool can include a distal end connected to a handle by an elongate shaft. In various embodiments, the shaft can be fixed, telescoping, or flexible (e.g., “gooseneck” shaft). Some such shafts (also called “wands”) are described in U.S. Patent Publication No. US20100163730, corresponding to U.S. patent application Ser. No. 12/647,175, filed Dec. 24, 2009, and entitled “INFRARED IMAGING PROBE,” which is assigned to the assignee of the instant application, and which is hereby incorporated by reference in its entirety. In some examples, the distal end can include one or more sensors configured to receive data from its surroundings.

Exemplary imaging tools can include one or more imaging components configured to detect electromagnetic radiation from a target scene. As described with respect to other imaging tools, imaging components can be configured to detect light in any number of various wavelength ranges, including but not limited to Visible, NIR, SWIR, LWIR, Terahertz, Ultraviolet, and X-Ray. In various examples, the distal end of the imaging tool can include any combination of audio microphones, temperature sensors, humidity sensors, or any other sensor capable of detecting information of the surrounding area. The distal end can coupled to the shaft by any number of various ways. In some examples, the distal end can be fixed to the shaft, attached via a gimbal mount, ball mount, omnidirectional mount, or other appropriate attachment mechanism. Some such attachments permit the distal end to move on the shaft and increase operability of the imaging tool.

The handle of the imaging tool can be configured to facilitate gripping of the imaging tool by the user. In some examples, the handle can be positioned at the proximate end of the imaging tool. In other embodiments, the handle can be positioned elsewhere on the imaging tool. In some examples, the handle can include an interface for attaching to the test and measurement tool. The interface can include at least one of one or more attachment mechanisms for securing the imaging tool to the test and measurement tool. In other examples, such attachment mechanisms can be incorporated into a proximate end of the imaging tool separately from the handle.

In some examples, the handle can be affixed or attached to various mounting mechanisms or platforms to permit hands-free operation of the imaging tool. The handle can be attached, for example, via a clip, magnet, socket, latch, suction cup, one or more nails or screws, or any other appropriate mounting mechanism. In various configurations, the handle can be permanently or temporarily affixed to a location convenient for desired operation by the user. In some alternative configurations, the test and measurement tool can be supported by a mounting mechanism or platform and can in turn support imaging tool in a similar location.

Imaging tool can be attached to and generally placed in communication with the test and measurement tool. In some examples, the imaging tool can be plugged into the test and measurement tool directly. The imaging tool can communicate with the test and measurement tool via a wired or wireless connection. In some examples, the imaging tool is configured to transmit information or detected data via the connection to the test and measurement tool. Data from one or more imaging components (e.g., sensor arrays) at the distal end can be conveyed to the test and measurement tool through a physical wired connection through the handle or distal end or wirelessly through a wireless radio contained within part of the imaging tool (e.g., distal end, shaft, or handle). In an exemplary embodiment, the imaging tool can be secured to a mounting mechanism or platform via the handle and remain in wireless communication with the test and measurement tool. In such an embodiment, a user can operate the test and measurement tool and the imaging tool simultaneously from a location separate from the affixed imaging tool. In some embodiments, the imaging tool can include on-board memory in which data could also be stored. In some further examples, imaging tool can include a power source and operate in a stand-alone mode as an imaging tool.

The imaging tool can receive data or instructions from the test and measurement tool. For instance, in the event that the distal end is attached to the shaft via a movable mount (e.g., omnidirectional mount, gimbal mount), the imaging tool can receive instruction from the test and measurement tool to reposition the distal end on the shaft. In some examples, the test and measurement tool can cause the distal end of the imaging tool to pivot, rotate, or perform any other available movements. Such movement can be actuated by one or more servos, actuators, or other known positioning device. In general, the position of the distal end can be controlled in a manual fashion, an electro-mechanical fashion, or remotely using micro-servos or other actuators wirelessly operated from either controls on the handle, controls on the primary test tool or controls on the portable device.

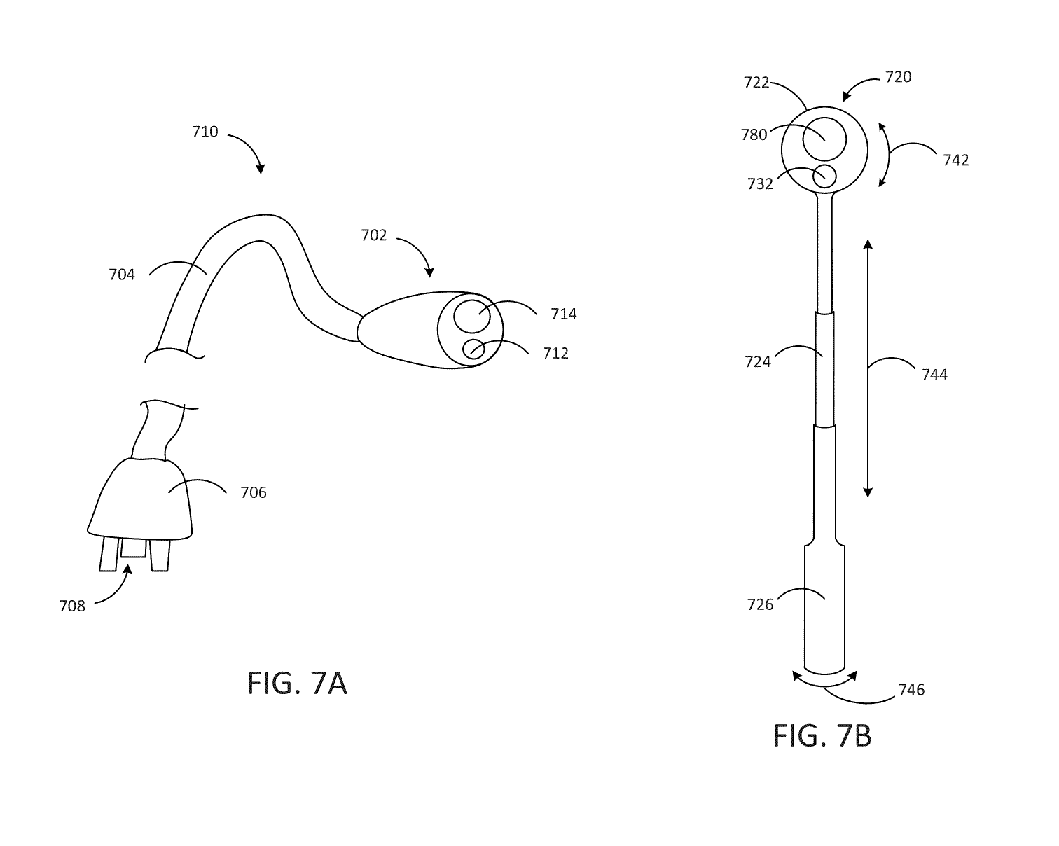

FIGS. 7A and 7B show exemplary imaging tools for attachment to a test and measurement tool. In the embodiment of FIG. 7A, imaging tool 710 includes a flexible shaft 704 connecting a handle 706 and a distal end 702. The handle 706 can facilitate gripping by a user. In some examples, the handle 706 is configured to engage the test and measurement tool for securing the imaging tool 710 thereto. The handle can include an interfacing portion 708 configured to interface with the test and measurement tool. In some examples, interfacing portion 708 is used to secure the imaging tool 710 to the test and measurement tool. In the illustrated embodiment, the distal end 702 includes an infrared (IR) camera (714) and a visible light (VL) camera (712) for acquiring IR and VL image data of a target scene, respectively. The flexible shaft 704 facilitates maneuvering the distal end 702 (and thus the cameras, adjusting their fields of view), as desired by the user. Accordingly, the imaging tool 710 can acquire image data representative of hard-to-reach places or otherwise indirect paths. In some embodiments, the imaging tool 710 can communicate at least one of the IR and VL image data to the test and measurement tool via the handle 706 (e.g., interfacing portion 708). In other embodiments, the imaging tool 710 can include a wireless radio for transmitting data to a test and measurement tool or other device capable of receiving data.

The imaging tool 720 of FIG. 7B includes a telescoping shaft 724 connecting a handle 726 to a distal end 722. In the illustrated embodiment, the distal end 722 includes an IR camera 730 and a VL camera 732 for acquiring IR and VL image data of a target scene, respectively. The distal end 722 can be attached to the telescoping shaft 724 via a gimbal or other connector that permits rotation about at least one axis, allowing the distal end 722 to be positioned along arrow 742 for adjusting the position of the distal end 722. In embodiments including one or more imaging devices, such as the illustrated embodiment, the adjustable position of the distal end 722 relative to the telescoping shaft 724 allows for the adjustment of the target scene viewed by the one or more imaging devices.

The telescoping shaft 724 coupled between the distal end 722 and the handle 726 can be adjusted along arrow 744 in order to adjust the position of the distal end 722 relative to the handle 726. For example, the distal end can be moved closer to or further from the handle 726 in order to adjust the relative length of the imaging tool 720. The telescoping shaft 724 can facilitate movement of the distal end 722 further away from the handle 726 to permit analysis (e.g., imaging) of hard-to-reach or otherwise inaccessible areas.

The handle 726 can facilitate gripping by a user. In some examples, the handle is configured to engage the test and measurement tool for securing the imaging tool 720 thereto. In some examples, when secured to the test and measurement tool, the handle 726 can be configured to pivot or rotate in the direction along arrow 746 for adjusting the direction the imaging tool is facing. In embodiments including one or more imaging devices, such as the illustrated embodiment, rotating the handle 726 along arrow 746 allows for adjusting the target scene viewed by the one or more imaging devices.

In various embodiments, motion of all or parts of the imaging tool 720 (e.g., along arrows 742, 744, 746) can be performed manually by a user. Additionally or alternatively, such motion can be performed by one or more servos or other components capable of effecting motion. Such motion can be actuated via a user interface, for example on the test and measurement tool or the portable device.

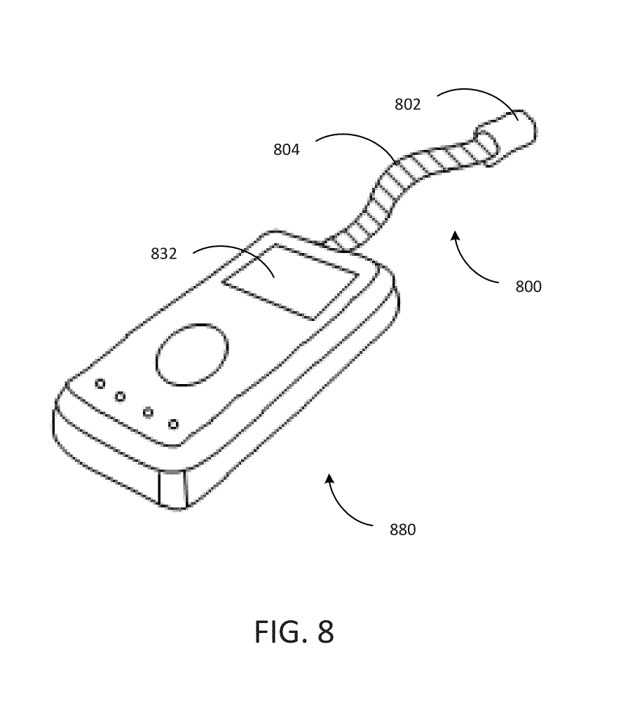

FIG. 8 is an exemplary embodiment of an imaging tool coupled to a test and measurement tool. In the illustrated embodiment, the imaging tool 800 includes a flexible shaft 804 coupled to a distal end 802. The imaging tool 800 can be attached to a test and measurement tool 830, for example via a handle (not shown). The test and measurement tool 830 can include a display 832 for displaying data acquired by the imaging tool 800. In some embodiments, the display 832 of the test and measurement tool 830 is configured to display both data received from the imaging tool 800 (e.g., IR and/or VL image data) and also data collected from the test and measurement tool 830 (e.g., current or voltage data from a digital multimeter). In various embodiments, the image data (e.g., IR and VL image data) can be combined, manipulated, and displayed, for example as described in U.S. Pat. No. 7,535,002, which is incorporated by reference.

In some embodiments, various imaging tools are interchangeably attachable to a test and measurement tool. For instance, the imaging tool 710 including the flexible shaft 704 of FIG. 7A can be attached to a test and measurement tool and used in conjunction therewith. Once the use of the imaging tool 710 is complete, a user can interchange the imaging tool 710 of FIG. 7A with the imaging tool 720 of FIG. 7B, including the telescoping shaft 724. As such, the user can continue to operate the same test and measurement tool, and modify the capabilities of the imaging tool interfacing therewith.

In some embodiments, a test and measurement tool may be capable of measuring high voltages. Accordingly, in some instances, such high voltages may at times be present within circuitry (e.g., electronics 222) of the test and measurement tool. Standards and practices exist to protect users of typical test and measurement tools from being exposed to such high voltages. For example, solid state insulation and sufficient component spacing may be used to provide protective electrical isolation to a user. When an imaging tool is incorporated (e.g., built-in, removably attached, etc.) into a test and measurement tool capable of performing such high-voltage measurements, protective isolation to the user must be provided, but without sacrificing performance of the imaging tool. In some embodiments, electrical isolation may be incorporated into one or both of the test and measurement tool and the imaging tool such as described in U.S. patent application Ser. No. 14/855,864, filed Sep. 16, 2015, and entitled “MOBILE DEVICE USED WITH ISOLATED TEST AND MEASUREMENT INPUT BLOCK,” or U.S. Provisional Patent Application No. 62/219,415, filed Sep. 16, 2015, and entitled “SYSTEMS AND METHODS FOR PLACING AN IMAGING TOOL IN A TEST AND MEASUREMENT TOOL,” each of which is assigned to the assignee of the instant application and is hereby incorporated by reference in its entirety.

FIG. 9 is an exemplary display showing combined image and measurement data. In the illustrated example, the display 900 includes measurement data 902 comprising a measurement of current flowing through three conductors and a measured voltage. In some examples, measurement data 902 may be acquired from a single test and measurement tool capable of measuring both current and voltage. In other examples, measurement data 902 comprising both voltage and current data may be acquired from a plurality of test and measurement tools, such as a volt meter and an ammeter or other current measuring device.

In still further embodiments, known information regarding the object under test may be used to supplement measurement data. For instance, if the resistance values of the conductors of FIG. 9 are known, voltage or current measurements may be used to calculate the other. In some such examples, supplementary information such as resistance values may be stored in memory or input by a user via a user interface, for example in response to a prompt.

In the illustrated embodiment, image data presented on the display includes infrared image data representative of the thermal pattern across the scene. In the illustrated example, the display 900 includes temperature information 912 representative of the temperature of a selected spot 914 on the display. In some examples, a user may adjust the location of spot 914 for displaying a temperature of an area of interest. The display 900 includes a temperature scale 916 that associates colors within a palettized IR image to corresponding temperature values. Any appropriate palettization scheme may be used, such as grayscale, red-blue, ironbow, amber, and others. The temperature scale 916 may be used to provide an indication to a viewer of the temperature of various points in the scene without requiring the placing of spot 914 over each point.

In some embodiments, other data 918 can be included in the display. Such data can include supplementary information for the image data (e.g., an emissivity value) or the measurement data. Other information that can be displayed include battery life information 920 or information data received from one or more other devices (e.g., test and measurement tools, imaging tools, etc.) or a network such as the internet. In various examples, such data can include information from specifications, FAQs, operating instructions, and the like.

In various embodiments, at least one of the location and content of displayed data is predetermined based on which devices are in communication. For instance, in one example, any acquired data (e.g., at least one parameter from the test and measurement tool, image data from the imaging tool, etc.) can be displayed on the test and measurement tool by default. In another example, any acquired data is automatically displayed on an external device if one is in communication with at least one of the test and measurement tool and the imaging tool. In some embodiments, a user can define what information is displayed on which devices. In some such embodiments, the user can make a selection via a user interface on any of the test and measurement tool, the imaging tool, or an external device regarding the type and location of displayed data using any of the available devices in communication with the system (e.g., test and measurement tool, imaging tool, external device, etc.).

Various embodiments have been described. Such examples are non-limiting, and do not define or limit the scope of the invention in any way. Rather, these and other examples are within the scope of the disclosure.

1. A system comprising
a test and measurement tool having a first surface and configured to generate measurement data representative of at least one parameter of an object under test;
an imaging tool comprising a sensor array for receiving radiation from a target scene and configured to generate image data representative of the target scene; wherein
the imaging tool is configured to engage the first surface of the test and measurement tool such that the imaging tool is supported by the test and measurement tool; and
when the imaging tool is engaged with the first surface of the test and measurement tool, the sensor array of the imaging tool is movable relative to the imaging tool such that the target scene is adjustable without movement of the test and measurement tool.

2. The system of claim 1, wherein the imaging tool is fixedly attached to the first surface of the test and measurement tool.

3. The system of claim 1, further comprising a processor configured to receive measurement data from the test and measurement tool and image data from the imaging tool, and to process the received measurement data and image data to generate a visual representation of combined measurement data and image data.

4. The system of claim 3, further comprising a display in communication with the processor and capable of displaying the generated visual representation.

5. The system of claim 4, further comprising an external device in communication with at least one of the imaging tool and the test and measurement tool, and wherein at least one of the processor and the display is positioned in an external device.

6. The system of claim 3, wherein the imaging tool is removable from the test and measurement tool.

7. The system of claim 6, wherein the processor is capable of communicating with the imaging tool only when the imaging tool is fixedly attached to the test and measurement tool.

8. The system of claim 1, wherein the imaging tool is mounted to the combination tool via a rotatable mount.

9. The system of claim 8, wherein the rotatable mount comprises a gimbal mount.

10. The system of claim 1, wherein the imaging tool comprises an elongate portion that is at least one of flexible and telescoping.

11. The system of claim 1, wherein the first surface of the test and measurement tool is a substantially planar surface.

12. The system of claim 1, wherein the first surface of the test and measurement tool is capable of removably receiving a plurality of different imaging tools.

13. The system of claim 1, wherein, when the imaging tool is engaged with the first surface of the test and measurement tool, the imaging tool is electrically isolated from at least a portion of the test and measurement tool.

14. The system of claim 1, wherein the imaging tool comprises a plurality of sensor arrays, each capable of detecting radiation from a different target scene.

15. The system of claim 14, further comprising a user interface by which a user can select from which of the sensor arrays to acquire image data.

16. A system comprising:
a test and measurement tool comprising a first surface and configured to generate measurement data representative of at least one parameter of an object under test;
an imaging tool attachable to the first surface of the test and measurement tool and comprising at least one sensor array for receiving radiation from a target scene; wherein the imaging tool is capable of generating image data representative of a plurality of target scenes when attached to the test and measurement tool without requiring movement of the test and measurement tool.

17. The system of claim 16, wherein at least one of the at least one sensory array is movable relative to test and measurement tool when the imaging tool is attached to the test and measurement tool.

18. The system of claim 17, wherein the imaging tool comprises a rotatable portion that is rotatable relative to the test and measurement tool when the imaging tool is attached to the test and measurement tool such that rotating the rotatable portion of the imaging tool changes the field of view of the sensor array.

19. The system of claim 17, wherein the imaging tool comprises an elongate portion supporting the at least one sensor array, and wherein the elongate portion comprises at least one of a telescoping portion and a flexible portion.

20. The system of claim 16, wherein the imaging tool comprises a plurality of sensor arrays, each of the plurality of sensor arrays having different fields of view.
